(19) United States
(12) Patent Application Publication
(10) Pub. No.: US 2011/0227809 A1
(43) Pub. Date: Sep. 22, 2011

(54) PATCH ANTENNA IN WIRELESS COMMUNICATION SYSTEM AND METHOD FOR MANUFACTURING THE SAME

(75) Inventors: Nam-Ki LEE, Seoul (KR); Seung-In YANG, Seoul (KR)

(73) Assignees: ELECTRONICS AND TELECOMMUNICATIONS RESEARCH INSTITUTE, Daejon (KR); Soongsil University Research Consortium techno-PARK, Seoul (KR)

(21) Appl. No.: 12/887,620

(22) Filed: Sep. 22, 2010

(30) Foreign Application Priority Data
Mar. 22, 2010 (KR) 10-2010-0025449

(51) Int. Cl. H01Q 15/10

(52) U.S. Cl. 343/909

(57) ABSTRACT

A patch antenna in a wireless communication system includes a patch antenna unit positioned at a predetermined point on a substrate; a first cover of a high-gain metamaterial of a different structure positioned over the patch antenna unit at a first distance from the substrate on which the patch antenna unit is positioned; and a second cover of a metamaterial of an identical structure positioned over the first cover at a second distance from the first cover. The first cover has a quadrilateral grid formed only on an outer periphery of a dielectric surface of the first cover.

### CROSS-REFERENCE TO RELATED APPLICATIONS

The present application claims priority of Korean Patent Application No. 10-2010-0025449, filed on Mar. 22, 2010, which is incorporated herein by reference in its entirety.

### BACKGROUND OF THE INVENTION

1. Field of the Invention

Exemplary embodiments of the present invention relate to a wireless communication system; and, more particularly, to a patch antenna using a cover of a high-gain metamaterial structure and thus having high gain in a wireless communication system, and a method for manufacturing the patch antenna.

2. Description of Related Art

Various types of antennas have been proposed to transmit/receive signals in wireless communication systems, and patch antennas, among them, have the advantages of compact sizes, lightness, ease of fabrication, and low costs. However, the patch antennas have a problem in that it is difficult to increase their bandwidth, and they induce substantial coupling loss, making it difficult to use the patch antennas in high-frequency bands.

In an attempt to alleviate such problems of the patch antennas, various structures of patch antennas have been proposed. Specifically, there is ongoing study to further improve the gain of patch antennas.

However, currently proposed patch antennas have limited sizes, which then restrict the increase of bandwidth. Furthermore, it is difficult to acquire gain requested in the frequency band to be used, specifically high-frequency band. Therefore, there is a need for a patch antenna which can be used in a high-frequency band, and which can acquire at least a predetermined degree of gain in the high-frequency band.

### SUMMARY OF THE INVENTION

An embodiment of the present invention is directed to a patch antenna having high gain in a wireless communication system and a method for manufacturing the patch antenna.

Another embodiment of the present invention is directed to a patch antenna using a cover of a high-gain metamaterial structure and thus having high gain in a wireless communication system and a method for manufacturing the patch antenna.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a patch antenna in a wireless communication system includes: a patch antenna unit positioned at a predetermined point on a substrate; a first cover of a high-gain metamaterial of a different structure positioned over the patch antenna unit at a first distance from the substrate on which the patch antenna unit is positioned; and a second cover of a metamaterial of an identical structure positioned over the first cover at a second distance from the first cover, wherein the first cover has a quadrilateral grid formed only on an outer periphery of a dielectric surface of the first cover.

In accordance with another embodiment of the present invention, a method for manufacturing a patch antenna in a wireless communication system includes: forming a patch antenna unit at a predetermined point on a substrate; positioning a first cover of a high-gain metamaterial of a different structure over the patch antenna unit at a first distance from the substrate on which the patch antenna unit is formed; and positioning a second cover of a metamaterial of an identical structure over the first cover at a second distance from the first cover, wherein in said positioning the first cover, a quadrilateral grid is formed by etching only an outer periphery of a dielectric surface of the first cover.

### BRIEF DESCRIPTION OF THE DRAWINGS

FIG. 1 is a schematic cross-sectional view of a patch antenna in a wireless communication system in accordance with an embodiment of the present invention.

FIG. 2 schematically illustrates a grid formed on first and second covers of a patch antenna in a wireless communication system in accordance with an embodiment of the present invention.

FIG. 3 schematically illustrates a second cover of a patch antenna in a wireless communication system in accordance with an embodiment of the present invention.

FIG. 4 schematically illustrates a first cover of a patch antenna in a wireless communication system in accordance with an embodiment of the present invention.

FIG. 5 schematically illustrates a patch antenna implemented in accordance with an embodiment of the present invention.

FIG. 6 illustrates S-parameter characteristics of a patch antenna in a wireless communication system in accordance with an embodiment of the present invention.

FIGS. 7A and 7B illustrate E-plane characteristics of a patch antenna in a wireless communication system in accordance with an embodiment of the present invention.

FIGS. 8A and 8B illustrate E-plane characteristics of a patch antenna in a wireless communication system in accordance with an embodiment of the present invention.

FIGS. 9A, 9B, and 9C illustrate power flow characteristics of a patch antenna in a wireless communication system in accordance with an embodiment of the present invention.

FIG. 10 illustrates Voltage Standing Wave Ratio (VSWR) characteristics of a patch antenna in a wireless communication system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention proposes a patch antenna using a cover of a high-gain metamaterial structure and thus having high gain in a wireless communication system, and a method for manufacturing the patch antenna. In accordance with an embodiment of the present invention, a patch antenna unit is formed on a substrate, and first and second covers are successively positioned over the patch antenna unit. The first cover, which is positioned between the patch antenna unit and the second cover, has a high-gain metamaterial structure. Specifically, in accordance with an embodiment of the present invention, a first cover of a metamaterial of a different structure is positioned over a substrate on which a patch antenna unit is formed, and a second cover of a metamaterial of the same structure is positioned over the first cover, so that a patch antenna having high gain is implemented.

The first cover has a quadrilateral grid formed only on an outer periphery of a dielectric surface, specifically a radiation surface which emits signals, so that the first cover has a refractive index close to zero, and energy radiated from the patch antenna unit towards the outside of the path antenna is converted in the forward direction. The first cover, due to metamaterial characteristics, has negative dielectric constant and magnetic permeability, as well as a refractive index smaller than that of free space (i.e. low refractive index medium). Therefore, electromagnetic waves passing through the first cover are concentrated in one direction according to Snell's law, and are thus converted in the forward direction. The resulting patch antenna has improved directivity and high gain.

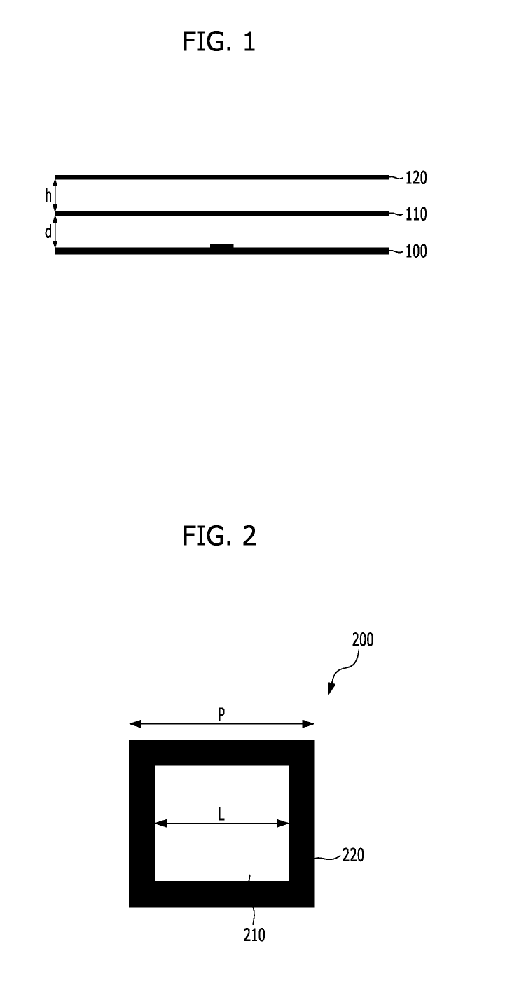

The second cover has a quadrilateral grid formed on an entire dielectric surface, specifically an entire radiation surface which emits signals, so that the second cover increases the forward directionality of the patch antenna and improves the overall gain of the patch antenna. In other words, the above-mentioned first and second covers of the patch antenna in accordance with an embodiment of the present invention decrease sidelobe beams among antenna beams and increase the forward directionality of the patch antenna, thereby implementing a high-gain patch antenna. The structure of a patch antenna in a wireless communication system in accordance with an embodiment of the present invention will now be described in more detail with reference to FIGS. 1 to 5.

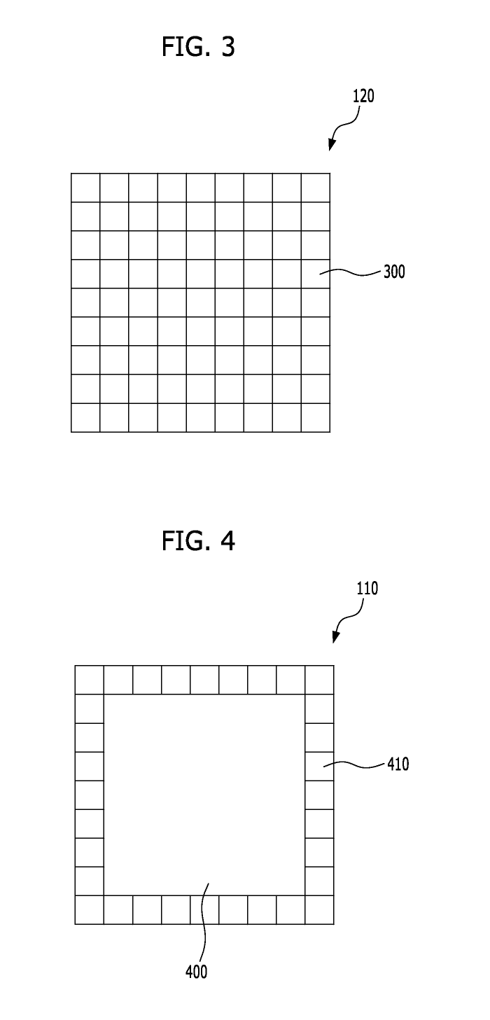

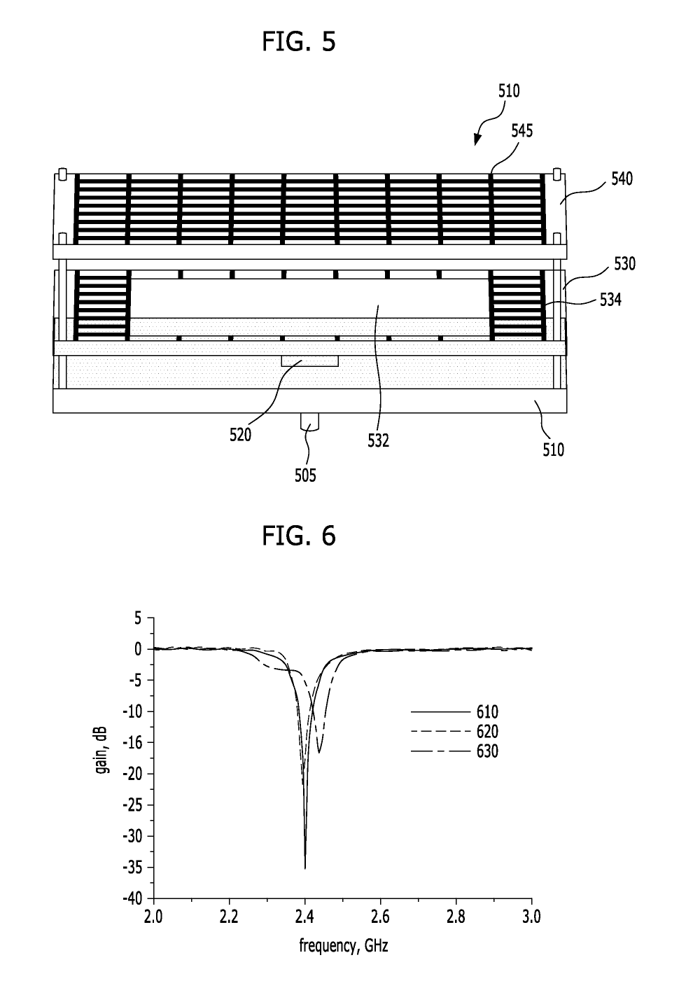

FIGS. 1 to 5 illustrate a schematic structure of a patch antenna in a wireless communication system in accordance with an embodiment of the present invention. Specifically, FIG. 1 is a schematic cross-sectional view of the patch antenna. FIG. 2 schematically illustrates a grid formed on first and second covers of the patch antenna. FIG. 3 schematically illustrates a second cover of the patch antenna. FIG. 4 schematically illustrates a first cover of the patch antenna. FIG. 5 schematically illustrates a patch antenna implemented in accordance with an embodiment of the present invention.

Referring to FIGS. 1 to 5, the patch antenna 500 includes a substrate 100, 510 and a patch antenna unit 105, 520 formed on the substrate 100, 510. A first cover 110, 530 is positioned at a predetermined distance (d) in the upward direction from the patch antenna unit 105, 520, i.e. in the signal radiation direction, and a second cover 120, 540 is positioned at a predetermined distance (h) in the upward direction from the first cover 110, 530. Grids 200, 300, 410, 534, 545 are formed by etching a surface of the first cover 110, 530 and the second cover 120, 540, respectively, specifically a signal radiation surface of dielectric substances implementing the first cover 110, 530 and the second cover 120, 540.

More specifically, the grids 200, 300, 410, 534, 545 are formed by etching a dielectric surface of the first cover 110, 530 and the second cover 120, 540, respectively, from the outer periphery length (P) to the inside length (L) with reference to the center. The outer periphery length (P) and the inside length (L) are determined in conformity with a center frequency of the patch antenna 500. The outer periphery length (P) and the inside length (L), which are based on the center frequency, are defined by Equation 1 below.

P≈λ/4

L≈λ/5 Eq. 1

For example, when the center frequency of the patch antenna 500 is 2.4 GHz, the wavelength (λ) of the center frequency is 125 mm. Then, the outer periphery length (P) of the grids 200, 300, 410, 534, 545 is 35.5 mm, and the inside length (L) is 30.32 mm.

The quadrilateral grids 200, 300, 410, 534, 545 are formed by etching the first cover 110, 530 and the second cover 120, 540, respectively, so that, on the second cover 120, 540, the grid 300, 545 is periodically arranged on the entire dielectric surface. The second cover 120, 540, which has a grid 300, 545 formed on the entire dielectric surface, becomes a metamaterial cover of the same structure, increases forward directionality of the patch antenna 500, and improves overall gain of the patch antenna 500.

The first cover 110, 530 has a grid 410, 534 formed on a dielectric surface by etching only the outer periphery of the surface, i.e. excluding the center area 400, 532. The first cover 110, 530, which has a grid 410, 534 formed only on the outer periphery of a dielectric surface, has a refractive index close to zero so that energy radiated from the patch antenna unit 105, 520 to the outside of the patch antenna 500 is converted in the forward direction.

The first cover 110, 530, due to metamaterial characteristics, has negative dielectric constant and magnetic permeability, as well as a refractive index smaller than that of free space (i.e. low refractive index medium). Therefore, electromagnetic waves passing through the first cover 110, 530 are concentrated in one direction according to Snell's law, and are thus converted in the forward direction. The resulting patch antenna has improved directivity and high gain. In other words, the first cover 110, 530 and the second cover 120, 540 decrease sidelobe beams among beams of the patch antenna 500 and increase the forward directionality of the patch antenna 500, thereby implementing a high-gain patch antenna 500. The gain of a patch antenna 500 in accordance with an embodiment of the present invention is defined by Equation 2 below.

Dₘₐₓ=4πA/λ²

Gₘₐₓ=kDₘₐₓ

Gₘₐₓ=10 log(4πA/λ²) Eq. 2

In Equation 2 above, Dₘₐₓ denotes maximum directionality of the patch antenna 500, A denotes the area of the patch antenna 500, Gₘₐₓ denotes maximum gain of the patch antenna 500, and k denotes efficiency. The patch antenna 500 has the maximum gain when k is 1. For example, when the antenna area is 319.5 mm×319.5 mm at a center frequency of 2.4 GHz, as mentioned above, the wavelength (λ) of the center frequency is 125 mm, and the maximum gain is 19.14 dBi.

The distance (d) between the substrate 100, 510, on which the patch antenna unit 105, 520 is formed, and the overlying first cover 110, 530 and the distance (h) between the first cover 110, 530 and the overlying second cover 120, 540 are determined in conformity with the center frequency of the patch antenna 500, as defined by Equation 3 below.

d≈λ/4˜λ/3

h≈λ/4 Eq. 3

For example, when the center frequency is 2.4 GHz, as mentioned above, the distance (d) between the substrate 100, 510, on which the patch antenna unit 105, 520 is formed, and the first cover 110, 530 is 19 mm, and the distance (h) between the first cover 110, 530 and the second cover 120, 540 is 41 mm. Specifically, it will be assumed for simulation that the center frequency is 2.4 GHz, the dielectric constant is 2.33, the substrate has a thickness of 1.524 mm, the copper plate has a thickness of 0.035 mm, and the patch antenna 500 has an overall size of 340 mm×340 mm. Then, the following implementation is possible: the path antenna unit 105, 520 has a size of 38.55 mm×46.95 mm, the first cover 110, 530 of a high-gain metamaterial structure has a dielectric constant of 2.2, the substrate has a thickness of 0.5 mm, and the copper has a thickness of 0.018 mm.

When the patch antenna 500 implemented in this manner is supplied with power through a feeding terminal 505, the first cover 110, 530 and the second cover 120, 540 of a high-gain metamaterial structure decrease sidelobe beams and increase forward directionality, as mentioned above, so that the patch antenna 500 acquire high gain. The performance of a patch antenna 500 in accordance with an embodiment of the present invention will now be described in more detail with reference to FIGS. 6 to 10.

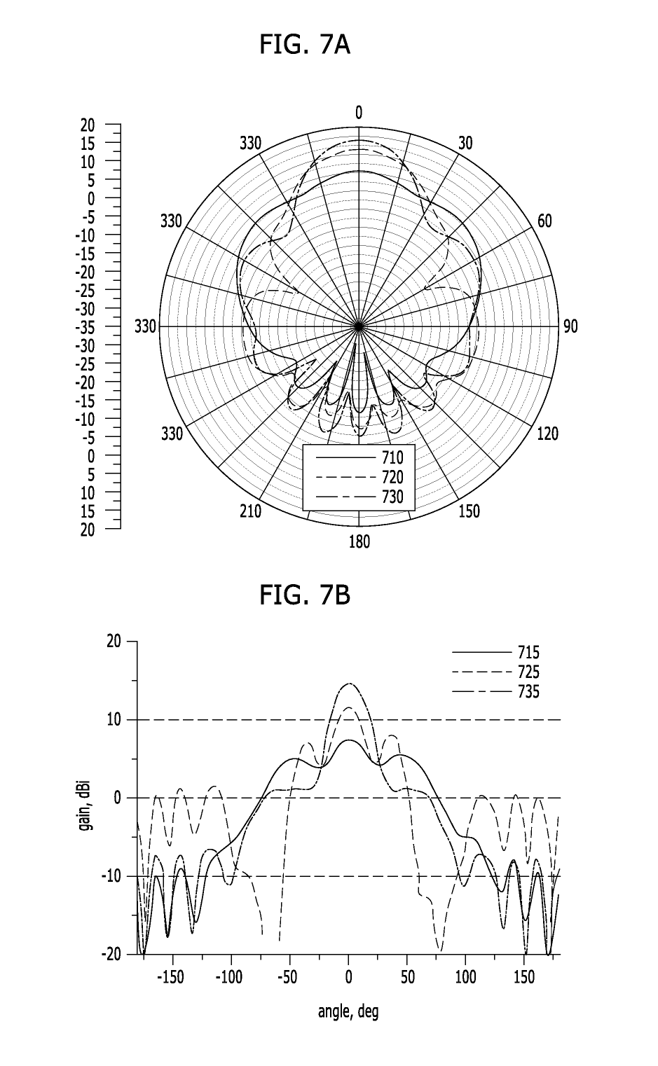

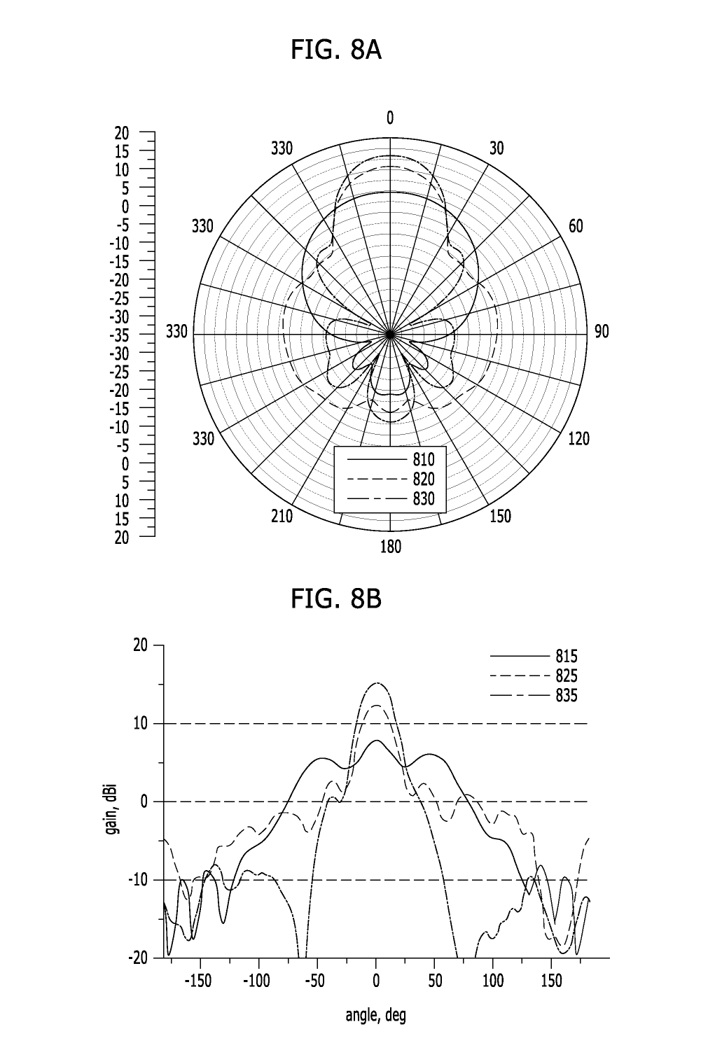

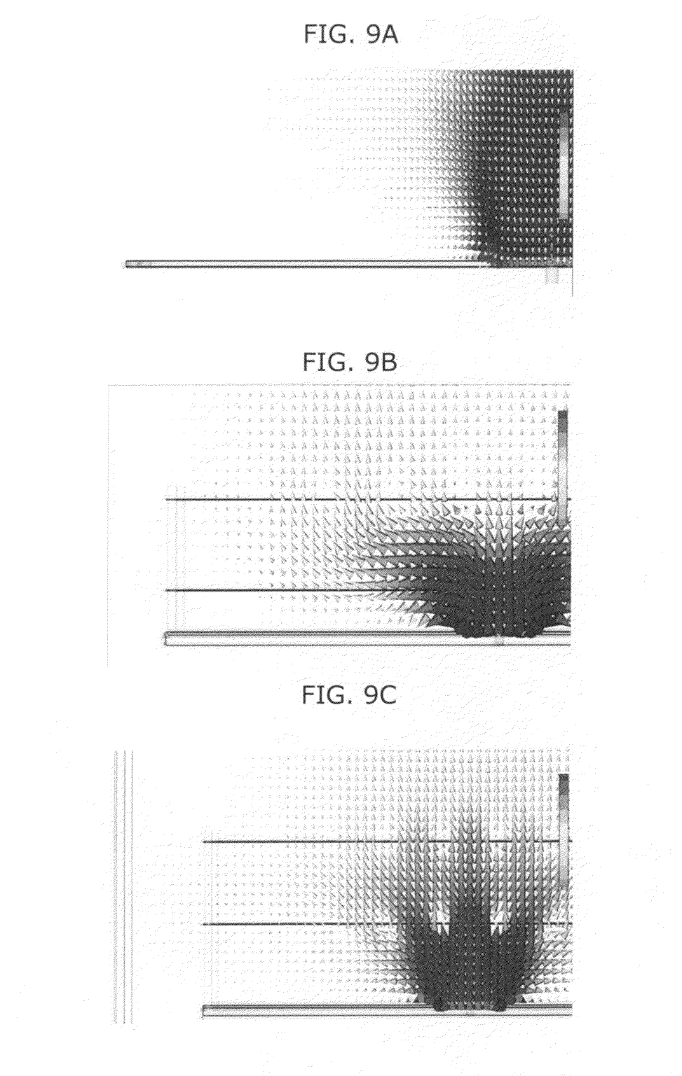

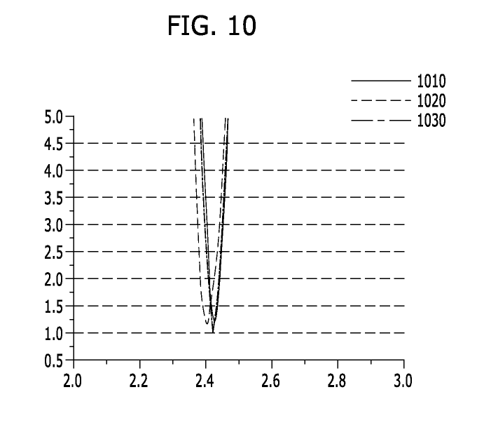

FIGS. 6 to 10 illustrate characteristics of a patch antenna in a wireless communication system in accordance with an embodiment of the present invention. Specifically, FIG. 6 illustrates S-parameter characteristics of the patch antenna. FIGS. 7A and 7B illustrate E-plane characteristics of the patch antenna. FIGS. 8A and 8B illustrate H-plane characteristics of the patch antenna. FIGS. 9A, 9B, and 9C illustrate power flow characteristics of the patch antenna. FIG. 10 illustrates Voltage Standing Wave Ratio (VSWR) characteristics of the patch antenna.

Referring to FIGS. 6 to 10, the S-parameter 610 of a patch antenna including only a patch antenna unit 105, 520 of a patch antenna 500 in accordance with an embodiment of the present invention (hereinafter, referred to as a first patch antenna), the S-parameter 620 of a patch antenna including two second covers 120, 540 (i.e. the first cover 110, 350 has the same structure as the second cover 120, 540) of a patch antenna 500 in accordance with an embodiment of the present invention (hereinafter, referred to as a second patch antenna), and the S-parameter 630 of a patch antenna 500 in accordance with an embodiment of the present invention (hereinafter, referred to as a third patch antenna) have different gains at a center frequency of 2.4 GHz. Specifically, at a center frequency of 2.4 GHz, the first patch antenna has S-parameter 610 of −35 dB, the second patch antenna has S-parameter 620 of −21.6 dB, and the third patch antenna has S-parameter 630 has −16.7 dB. As such, the patch antenna 500 in accordance with an embodiment of the present invention acquires high gain.

The first patch antenna has E-plane gain 710, 715 and H-plane gain 810, 815 of 7.7 dBi at 2.4 GHz, the second patch antenna has E-plane gain 720, 725 and H-plane gain 820, 825 of 13.7 dBi at 2.4 GHz, and the third patch antenna has E-plane gain 730, 735 and H-plane gain 830, 835 of 16.2 dBi at 2.4 GHz. This means that the patch antenna 500 in accordance with an embodiment of the present invention has gain improvement of about 3 dB.

In the case of power flow of the first patch antenna as FIG. 9A and power flow of the second patch antenna as FIG. 9B, there exists a flow of energy flowing out of the patch antenna, as well as a flow of energy flowing towards the outer periphery of covers between both covers. However, in the case of power flow of the third antenna patch as FIG. 9C, energy flows towards the second cover between the first and second covers, which means that the energy has forward directionality towards the second cover.

The first patch antenna has a VSWR 1010 of 1.02 at 2.4 GHz, the second patch antenna has a VSWR 1020 of 1.18 at 2.4 GHz, and the third patch antenna has a VSWR 1030 of 1.23 at 2.4 GHz, which means that the patch antenna 500 in accordance with an embodiment of the present invention exhibits substantial improvement.

In accordance with the exemplary embodiments of the present invention, a patch antenna is implemented using a cover of a high-gain metamaterial in a wireless communication system so as to increase the gain of the patch antenna and acquire high gain in a high-frequency band.

While the present invention has been described with respect to the specific embodiments, it will be apparent to those skilled in the art that various changes and modifications may be made without departing from the spirit and scope of the invention as defined in the following claims.

What is claimed is:

1. A patch antenna in a wireless communication system, comprising:
a patch antenna unit positioned at a predetermined point on a substrate;
a first cover of a high-gain metamaterial of a different structure positioned over the patch antenna unit at a first distance from the substrate on which the patch antenna unit is positioned; and
a second cover of a metamaterial of an identical structure positioned over the first cover at a second distance from the first cover, wherein
the first cover has a quadrilateral grid formed only on an outer periphery of a dielectric surface of the first cover.

2. The patch antenna of claim 1, wherein the second cover has the grid periodically arranged and formed on an entire dielectric surface of the second cover.

3. The patch antenna of claim 1, wherein the grid has an outer periphery length and an inside length determined by a center frequency of the patch antenna.

4. The patch antenna of claim 3, wherein the outer periphery length and the inside length are determined by the equation below:
P≈λ/4
L≈λ/5
wherein P denotes the outer periphery length, and L denotes the inside length.

5. The patch antenna of claim 1, wherein the patch antenna further comprises a feeding terminal for supplying the patch antenna unit with power, and the grid is formed on radiation surfaces of the first and second covers, respectively, during power supply through the feeding terminal.

6. The patch antenna of claim 1, wherein the first and second distances are determined by a center frequency of the patch antenna.

7. The patch antenna of claim 6, wherein the first and second distances are determined by the equation below:
d≈λ/4˜λ/3
h≈λ/4
wherein d denotes the first distance, and h denotes the second distance.

8. A method for manufacturing a patch antenna in a wireless communication system, comprising:
forming a patch antenna unit at a predetermined point on a substrate;
positioning a first cover of a high-gain metamaterial of a different structure over the patch antenna unit at a first distance from the substrate on which the patch antenna unit is formed; and
positioning a second cover of a metamaterial of an identical structure over the first cover at a second distance from the first cover, wherein
in said positioning the first cover, a quadrilateral grid is formed by etching only an outer periphery of a dielectric surface of the first cover.

9. The method of claim 8, wherein in said positioning a second cover of a metamaterial of an identical structure over the first cover at a second distance from the first cover,
the grid is formed by etching an entire dielectric surface of the second cover so that the grid is periodically arranged on the entire dielectric surface.

10. The method of claim 8, wherein the grid has an outer periphery length and an inside length determined by a center frequency of the patch antenna.

11. The method of claim 10, wherein the outer periphery length and the inside length are determined by the equation below:
P≈λ/4
L≈λ/5
wherein P denotes the outer periphery length, and L denotes the inside length.

12. The method of claim 8, wherein the method further comprises forming a feeding terminal on the substrate to supply the patch antenna unit with power, and the grid is formed on radiation surfaces of the first and second covers, respectively, during power supply through the feeding terminal.

13. The method of claim 8, wherein the first and second distances are determined by a center frequency of the patch antenna.

14. The method of claim 13, wherein the first and second distances are determined by the equation below:
d≈λ/4˜λ/3
h≈λ/4
wherein d denotes the first distance, and h denotes the second distance.
